(19) United States
(12) Patent Application Publication
(10) Pub. No.: US 2013/0010622 A1
(43) Pub. Date: Jan. 10, 2013

(54) MULTIPLE BEARER RADIO SYSTEMS

(75) Inventors: Clive Douglas Horn, Christchurch (NZ); Tanmay Bhola, Christchurch (NZ)

(73) Assignee: TAIT LIMITED, Christchurch (NZ)

(21) Appl. No.: 13/542,062

(22) Filed: Jul. 5, 2012

Related U.S. Application Data
(60) Provisional application No. 61/504,665, filed on Jul. 5, 2011.

(51) Int. Cl. H04W 4/22; H04W 24/00; H04W 72/08

(52) U.S. Cl. 370/252; 370/328; 370/329

(57) ABSTRACT

Multiple bearers such as LTE and P25 in a radio system are used to provide diversity and therefore more reliable signal transmissions. The bearers are ranked according to one or more quality characteristics and uplink or downlink messages are transmitted using the best available path at that time. Emergency messages are transmitted simultaneously on all available bearers.

### CROSS-REFERENCE TO RELATED APPLICATIONS

This application claims priority to U.S. Provisional Patent Application Ser. No. 61/504,665 entitled “Multiple Bearer Radio Systems,” filed on 5 Jul. 2011, the disclosure of which is incorporated herein by reference in its entirety.

### FIELD OF THE INVENTION

This invention relates to multi-bearer radio systems and in particular, but not only, to systems used for public safety such as LTE (3GPP Long Term Evolution) and P25 (APCO 25). More particularly the invention relates to diversity techniques and emergency communications involving multiple bearers such as LTE and P25.

### BACKGROUND TO THE INVENTION

Within Land Mobile Radio (LMR) operations there are a number of techniques used to extend coverage. It is typical to find LMR systems which use either scanning, voting or simulcast. Each mode of operation represents a technique for both extending coverage and offering either near or complete seamless mobile connectivity.

In the case of scanning, the same information (voice or data) is sent on the downlink from the same signal source (e.g a dispatch terminal) but travels over the air interface through being transmitted at different sites on different frequencies. FIG. 1 illustrates two downlink frequencies though more are commonly used. Scanning can also be used to monitor multiple streams of information (e.g multiple voice calls).

The radio terminal 10 in FIG. 1 is alternating its receiver between downlink frequencies f1 and f2 attempting to detect the presence of a message from downlink source 11 as a radio signal from base station 12 or 13. Once a signal is detected, and if the signal is addressed to that terminal as either group message or individual message, the terminal remains on the particular frequency to receive the remainder of the downlink transmission. This terminal mode of operation is referred to as scanning

In an alternative mode of operation, the terminal measures the signal quality on both f1 and f2 before ranking the best one and selecting it for reception where upon the terminal remains on the best channel for the remainder of the downlink transmission. This is referred to as voting.

The definition of best channel can take a number of forms such as signal strength, bit error rate, out of band signal status (squelch), synchronisation confidence, preamble confidence level, vocoder FEC correction rate (in the case of voice) or FEC correction rate or message error rate for data packets. Generally any or all of these signal measures can be used to assess the signal quality.

In the case of both scanning and voting the transmissions from the separate sites do not require precise launch time synchronisation. A difference of 100 ms is typical. In the case of scanning, the terminal end is generally configured to listen to each channel and stay on the first channel it detects. In the case of voting, the terminal end generally listens to each channel in the list before making a decision as to which one is best.

FIG. 2 shows how an uplink transmission can occur on the same frequency in both scanning and voting. Here, the uplink frequency f3 is used by terminal 10. The signal is received by one or more of the sites and travels over the network to a network voter 20. Typically this voter will select the best message from each of these uplink paths before sending that message on to its destination 21. The destination may be a network element or simply repeating the data on the downlink. The same set of signal quality measures can be used for this assessment. By making this comparison, the voter is implicitly undertaking a technique called selection diversity.

Diversity is a technique which takes advantage of information transmitted over uncorrelated paths. Traditionally, diversity is considered as occurring over alternative channels over the same bearer such as spatial diversity (separate physical channels), frequency diversity (separate parts of the frequency band) and temporal diversity (sent at different times). Diversity can also be acquired through polarisation of a signal e.g vertical or horizontal polarisation through antenna orientation. The common thread to these transmissions is the independent paths are uncorrelated. Given this lack of correlation, it means that when observed at a destination receiver, the probability of either of the paths being of a good quality is greater than the probability of just one path being acceptable.

In another mode of operation, referred to as simulcast, the downlink frequencies are the same f1, see FIG. 3. Here, the same information is transmitted simultaneously from each site 12, 13. Simultaneous refers to a launch time accuracy of a few uS or more generally a small fraction of a symbol time. A simple terminal receiver is capable of good reception as long as the signals arrive within a specific delay difference, referred to as delay spread. A typical figure for APCO C4FM modulation is 30 uS for acceptable voice operation. More complex receiver types are capable of improved performance.

Public safety agencies around the world are considering the deployment of broadband bearers such as LTE for improving data connectivity in their radio systems. Utility industries such as electricity distribution are also looking to exploit similar technology. The expectation is to deploy this relatively wideband technology such as LTE to operate in parallel with existing narrow band systems such as P25. In the US, the FCC has made specific frequency allocations supporting this model of deployment.

The LTE standard is based on OFDM (Orthogonal Frequency Division Multiplexing) and can be deployed in a number of channel bandwidths such as a Frequency Division Duplex (FDD) mode where uplink/downlink pairs include 20 MHz, 15 MHz, 10 MHz, 5 MHz, 3 MHz and 1.4 MHz. These are FDD allocations so the total spectrum allocations are double the bandwidths listed here. In the US allocations of spectrum have been made representing 10+10 MHz in 3GPP band 14 for broadband operation. Specifically, the US has allocated frequencies 758 MHz to 768 MHz paired with 788 MHz to 798 MHz for broadband operation using LTE for Public Safety use. In addition, an allocation has been made for Public Safety for narrow band operation from 769 MHz to 775 MHz paired with 799 to 805 MHz. In other parts of the world private broadband allocations are being considered for use by public safety and critical infrastructure.

LTE coverage is made up of a number of frequency blocks, also referred to as resource blocks. An FDD 5 MHz channel has a set 25 resource blocks where each block is 180 kHz. Collectively the set of 25 blocks produces a bandwidth of 4.5 MHz within the 5 MHz channel with the 0.5 MHz remainder being used to contain the spectral skirts that operate within regulated emission masks. The channel is further divided into timeslots each of 0.5 ms, where a collection of 20 slots defines a frame. A resource block is therefore a block extending over a period which may include many timeslots. A set of frequency blocks contains many frames.

Each bearer in a wireless communication system requires a network of base stations to provide the channels over which users can communicate. The base stations are geographically located to provide coverage over a wide area within which the users are expected to move and require voice or data services. The users typically employ hand held or vehicle mounted terminals to communicate with the base stations. Each network generally includes a scheduler or controller which determines the timing and pathway of calls through the network. Bearer networks send control messages which are interpreted by the user terminals, in addition to voice and data messages which are sent between the users. Messages are typically composed of packets and the terms are used interchangeably in this specification.

### SUMMARY OF THE INVENTION

It is an object of the invention to provide for improved multi-bearer radio systems, or at least to provide alternatives for existing systems.

In one aspect the invention resides in a method for implementing downlink diversity for a multi-bearer radio communication system, including: transmitting a first copy of a message (or packet) on a downlink via a first radio bearer, transmitting a second copy of the message on a downlink via a second bearer, receiving the first and second copies at a radio terminal, and selecting or combining the received messages to improve radio coverage and/or reliability.

In another aspect the invention resides in a method for implementing a scheduler for a multi-bearer radio communication system including: assessing the link quality of a first bearer, assessing the link quality of a second bearer, and depending upon the relative quality of the links, scheduling communication over one or other bearer.

In another aspect the invention resides in a method for implementing uplink diversity in a multi-bearer radio communication system, including: transmitting a first copy of a message (or packet) on an uplink via a first radio bearer, transmitting a second copy of the message on an uplink via a second radio bearer, receiving the first and second copies at a network station, and selecting or combining the received messages to improve radio coverage and/or reliability.

In a further aspect the invention resides in a method of selecting a radio bearer at a multi-bearer terminal in a radio communication system, including: measuring downlink signal quality of data from a first bearer, measuring downlink signal quality of data from one or more further bearers, and either selecting an acceptable bearer for uplink communication, or continuing to measure downlink signal quality of the first and further bearers until an acceptable bearer is detected. In one embodiment the bearers are ranked before selection. The terminal may remain with a selected bearer until the bearer is no longer available, or may continue to measure bearers for further selection.

In a still further aspect the invention resides in a method for emergency communication in a public safety radio system having multiple bearers, including: activating an emergency process, transmitting emergency information on a first available bearer, and simultaneously transmitting emergency information on one or more further available bearers.

Connections between a terminal and an emergency service desk are therefore generally simultaneous rather than prioritised or sequential. This ensures that an emergency is reported as quickly as reasonably possible. In the case of emergency transmission in LTE, one or more Uplink Shared Channel (UL-SCH) is used irrespective of any scheduling grant and the transmission occurs at full power and using the strongest modulation coding rate irrespective of the interference that may cause.

### BRIEF DESCRIPTION OF THE DRAWINGS

Preferred embodiments of the invention will be described with respect to the accompanying drawings, of which:

FIG. 1 shows a typical LMR scanning/voting downlink.

FIG. 2 shows a typical LMR scanning/voting uplink.

FIG. 3 shows simulcast in LMR.

FIG. 4 shows a multi-bearer hub which enables bearer diversity.

FIG. 5 shows downlink diversity.

FIG. 6 outlines a process of selection of the best downlink message.

FIG. 7 shows an overlay of different bearers.

FIG. 8 shows multi-bearer uplink voting diversity.

FIG. 9 outlines a system for uplink voting.

FIG. 10 shows a process for selection of an uplink path.

FIG. 11 outlines another process for selection of an uplink path.

FIG. 12 shows a process for selection of a downlink path.

FIG. 13 shows selection of the downlink path.

FIG. 14 outlines a process for ranking the downlink.

FIG. 15 shows a scheduler for a multi-bearer system.

FIG. 16 outlines a process for sending emergency messages.

FIG. 17 outlines a process establishing multiple emergency connections.

FIG. 18 provides further detail relating to FIG. 17.

FIG. 19 shows typical components of a multi-bearer hub.

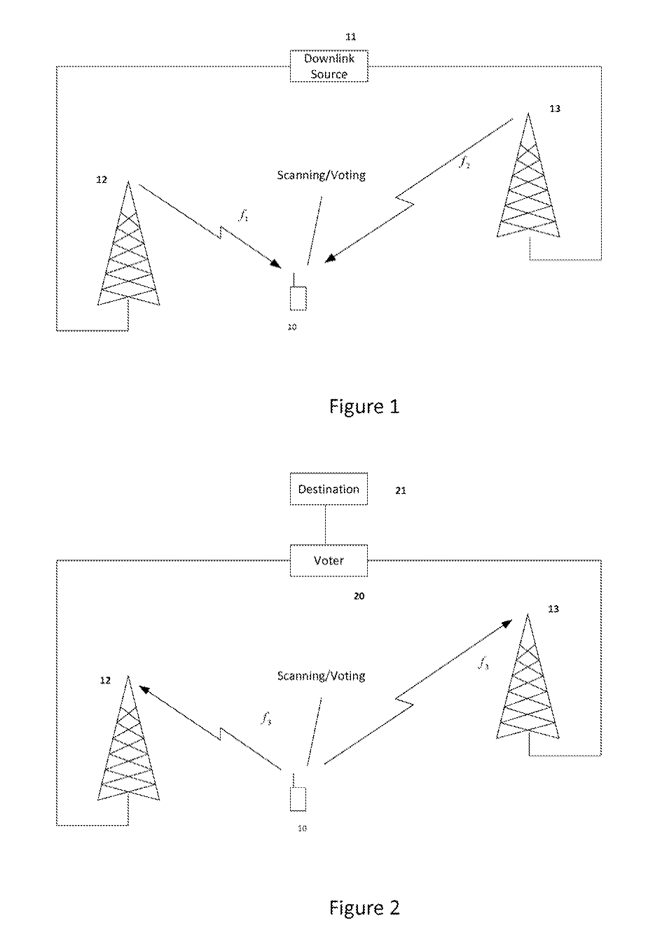

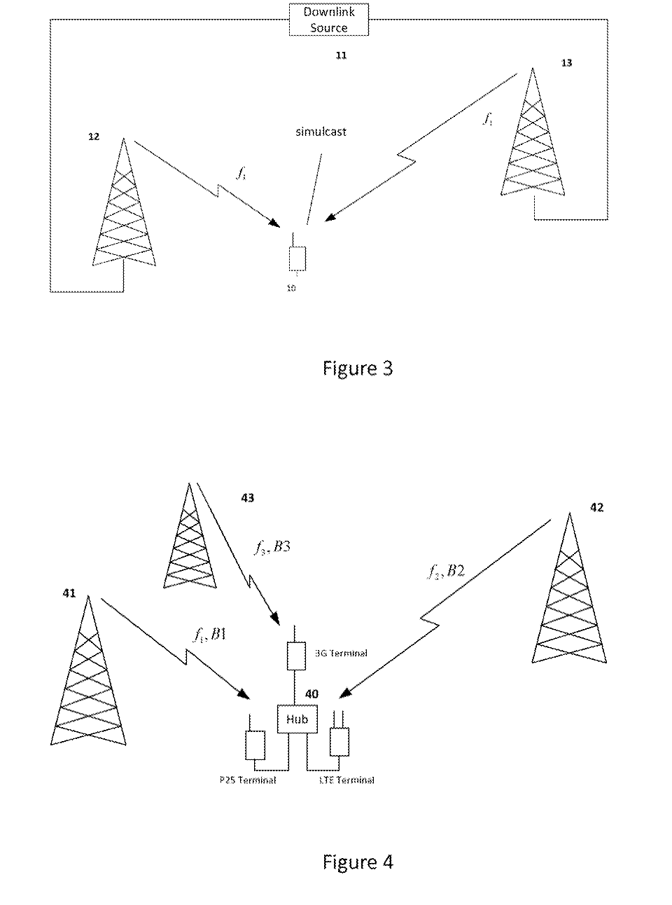

### DETAILED DESCRIPTION

Referring to the drawings it will be appreciated that the invention may be performed in a variety of ways using a range of different communication bearers. The preferred bearers LTE, P25 and 3G will be known to a skilled reader and need not be described in detail. It will also be appreciated that the embodiments described here are given by way of example only.

FIG. 4 illustrates the concept of a multi-bearer hub 40. In this example, the hub is a processing centre or controller which is connected simultaneously to a P25 terminal, a 3G terminal (e.g wCDMA) and an LTE terminal yielding three possible connection paths both uplink and downlink. A hub and two or more terminals is termed a unit in this specification. The P25 connection is shown as bearer B1 operating on f1 from site 41, the LTE connection is shown as bearer B2 operating on f2 from site 42, and the 3G connection is shown as bearer B3 operating on f3 from site 43. The frequency f1 can be any typical LMR frequency such as VHF or UHF. One example where LMR may operate is in the narrow band allocations from 769 MHz to 775 MHz paired with 799 to 805 MHz. The LTE connection can also be any frequency. One example where LTE may operate is in the US allocated frequencies 758 MHz to 768 MHz paired with 788 MHz to 798 MHz. Although three bearer technologies are shown here though more connections are possible such as Wifi.

Given connectivity to multiple bearers, the hub has options for the transmission or reception of the messages. Effectively the hub has the choice of a number of communication bearers. It may use one or more as required depending upon, but not limited to the following rules; bearer coverage available, bearer quality available and total data rate required. Generally, the hub and its connected set of radio devices are installed in a vehicle. An external device such as a PC, connected to the hub sees a single connection through which it is sending data. The hub there for is a piece of equipment itself connected to other radio bearers. The hub is generally connected to two or more bearers. The hub itself is making intelligent decisions as to which bearer to use. One example of an installation is within a public safety vehicle where the hub is directly connected to an LTE radio, installed somewhere in the vehicle, and a P25 radio, also installed somewhere in the vehicle, and a 3G radio installed somewhere else in the vehicle. In an alternative form, one or more of the radio bearers may be integrated into the hub itself.

It should be noted however the concept of the hub is not limited to a vehicle installation. It could be deployed in smaller version about a person such as a public safety officer. In this case the hub may be worn about the belt and connected to a P25 radio and an LTE radio. Effectively this forms a personal area network. Alternatively the hub could be installed in a fixed position and simply manage connectivity depending upon the instantaneous coverage available. In other words, if one link fails the hub will use another.

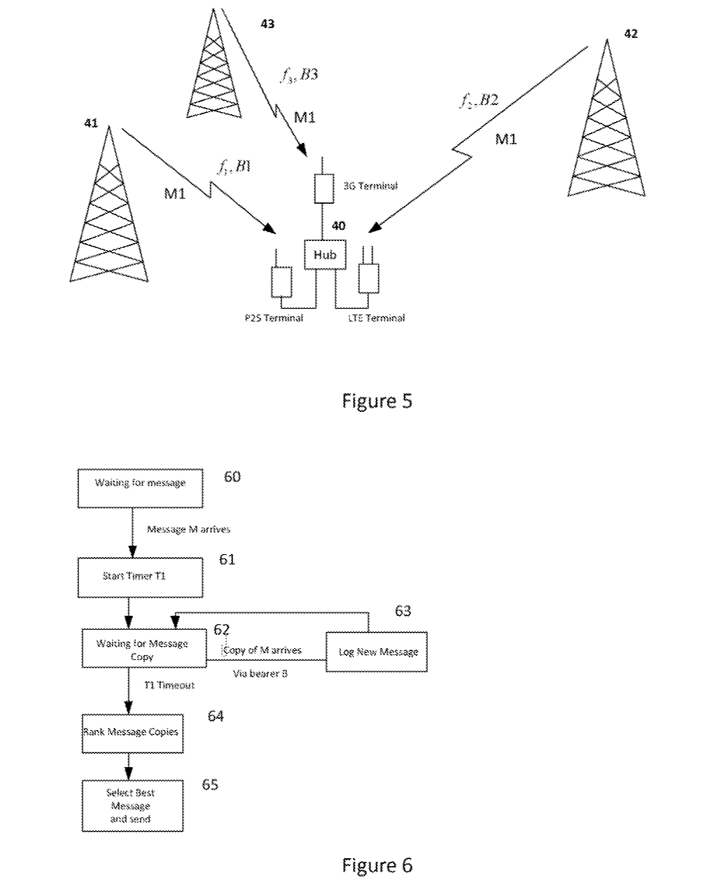

FIG. 5 shows a first mode of operation involving transmission of a message/packet M1 on the downlink. The same message M1 is transmitted over multiple media. This message is received by the hub 40 via one or more of the bearer technologies. This message is effectively a layer 2 message carried within an IP pipe. The message may have CRC flag to confirm correct reception or alternatively it may be protected by its own FEC.

The hub 40 can select one of the downlink messages it received via the different bearers. If a CRC check is passed, the hub could simply select the first message to arrive and discard further copies. Alternatively, the hub could base a decision on either best signal strength on the channel or lowest error rate on the channel. This provides improved performance of reception.

Given that the same message is transmitted over multiple media and the message is selected, it means the hub implicitly gains the benefit of selection diversity and thereby improves reception reliability. The terminal also benefits from seamless connectivity between bearers. In other words, the hub is capable of receiving data across multiple bearers as opposed to the traditional approach of solely across multiple frequencies. This mode of operation may be referred to as either multi-bearer scanning or multi-bearer simulcast.

FIG. 6 illustrates a process for selecting the message. Initially the hub is waiting 60 for the arrival of a message via which ever bearer. Given the arrival of a message M, a timer is started 61 which will cause the hub to wait 62 for further copies of the message to arrive over the other media. If whilst waiting for a message copy to arrive, a new copy appears, this message is logged 63. This process continues until such time the timer T1 timeout.

With each message that arrives, a quality measure is also stored. This quality measure can be as simple as signal strength. It can also be a bit error rate or channel state information. Assuming signal strength is used then it must be compared to a reference capability of the channel or a interference +noise floor, if known. In other words, the received signal strength approach must be a C/(I+N) figure. A better approach would be to compare the estimated bit error rates. This can be derived from either the FEC of each bearer though clearly each figure of merit needs to be compared to the nominal capability of the bearers.

Assuming signal strength alone is used for simplicity and by way of example. A good signal level for P25 reception is −100 dBm. A good signal level for an LTE receiver assuming 5 MHz FDD channel, is −80 dBm. If a message arrived on the P25 channel at −110 dBm and the same message arrives over LTE at −70 dBm then the LTE path should be accepted. The received messages are ranked 64 according to the quality indicator where-upon the best signal is selected 65.

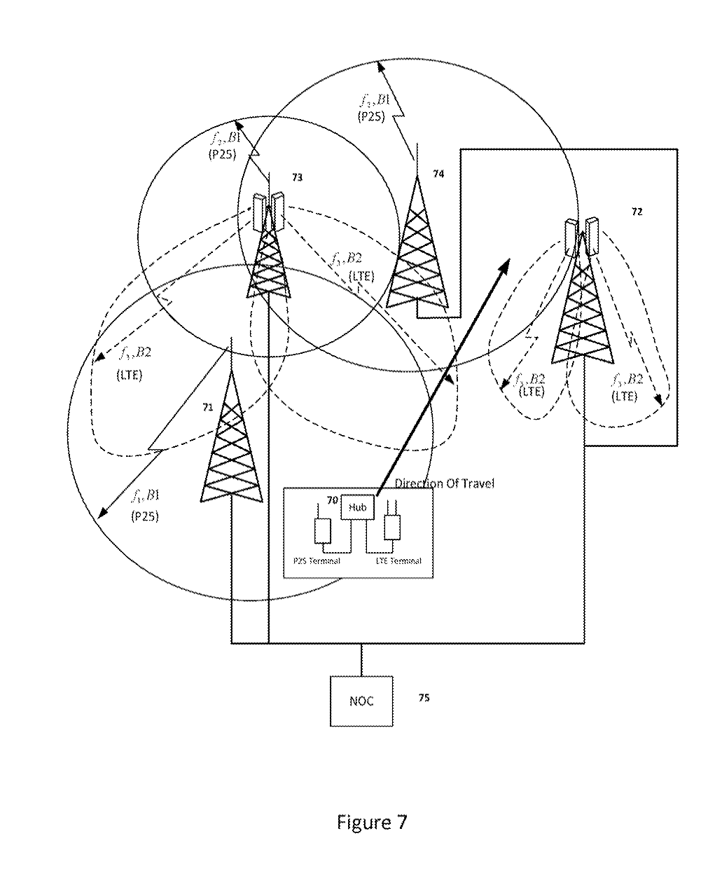

FIG. 7 illustrates an environment in which a hub 70 may operate. In this example the coverage overlay operation is limited to LTE and P25 only, to avoid overcomplicating the diagram. Four sites are illustrated, in which sites 71, 73 and 74 deploy P25 technology using an omni directional antenna. Sites 72 and 73 both offer LTE signals using directional antennas. In this illustration, sites 71 and 74 offer only P25 connectivity. Site 72 offers only LTE connectivity. Site 73 offers both P25 and LTE.

In FIG. 7 some geographic areas are served by one technology, other areas are served by more than one technology. The mobile unit, which may be installed within a vehicle, has both LTE and P25 radio connectivity is illustrated following a particular direction of travel. Following this direction of travel, the unit begins by having access P25 technology. It moves through an area where both signals are available before passing through a region of LTE only coverage and back into P25.

A unit with hub 70 is shown with more detailed contents of P25 and LTE radio connectivity and other mobile units are also shown is various geographic areas. From each of the physical sites, backhaul technology, be it fibre, microwave or wire is used to connect the system back to a Network Operations Centre (NOC) 75. The NOC is the back office location from where public safety operations are coordinated. It is from here that a dispatcher may use voice to offer specific commands. Alternatively the commander may use electronic messaging to issue commands and receive information regarding situational awareness. One example of situational awareness might be video streaming. Another example might be GPS location of each mobile hub.

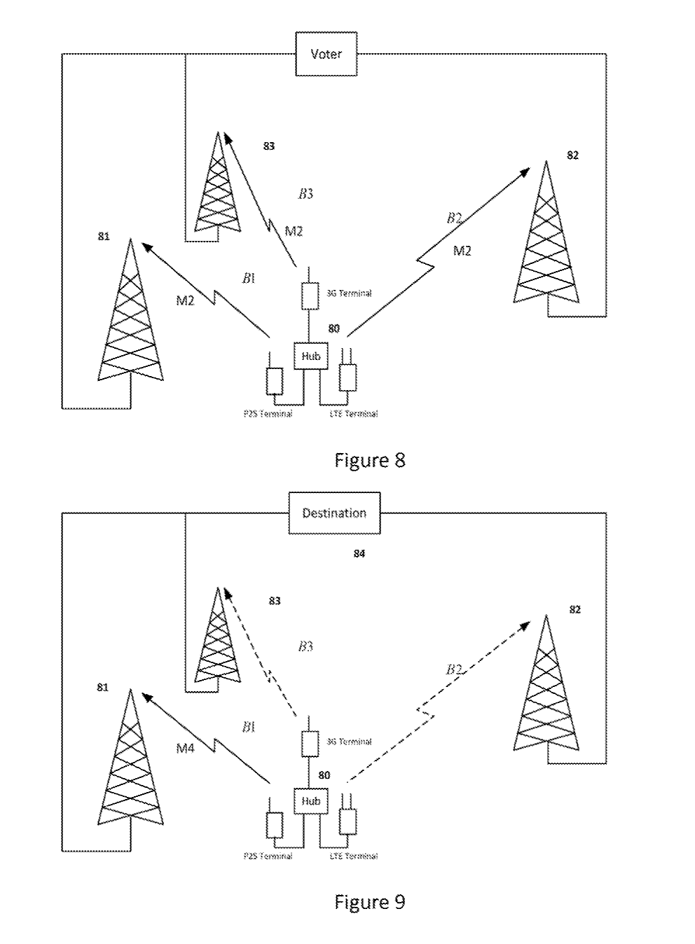

FIG. 8 shows a further mode of operation in which a message M2 is transmitted from a hub 80 to sites 81, 82, 83 over multiple bearers on the uplink. In this case, the bearers are now identified as B1, B2 and B3 and the frequency, timeslot or code is implied. Here, the same message arrives in the network via multiple bearers and arrives at the voter 84. The voter now selects which message to use and pass on to the destination. The message arrives over multiple bearer and this yields the benefit of diversity. In the simplest mode of operation, the first message to arrive may be selected. In an alternative mode, a number of same messages may arrive before one is selected based upon a quality measure.

FIG. 9 illustrates an alternative mode of operation in which a hub 80 can choose which bearer will carry the message in a form of uplink voting. The hub is periodically measuring the signal quality of the downlink channels for that particular bearer. In a simplest approach this may represent the presence of the bearer or not (i.e within coverage or not). It uses this measure of downlink quality (or presence) to make a decision as to which of the uplink paths it should use to transmit its message shown here as M4. The measure taken on the downlink may be signal strength, error rate or even channel state information. In the example shown, the hub has chosen to send its message up on the P25 bearer B1 to site 81.

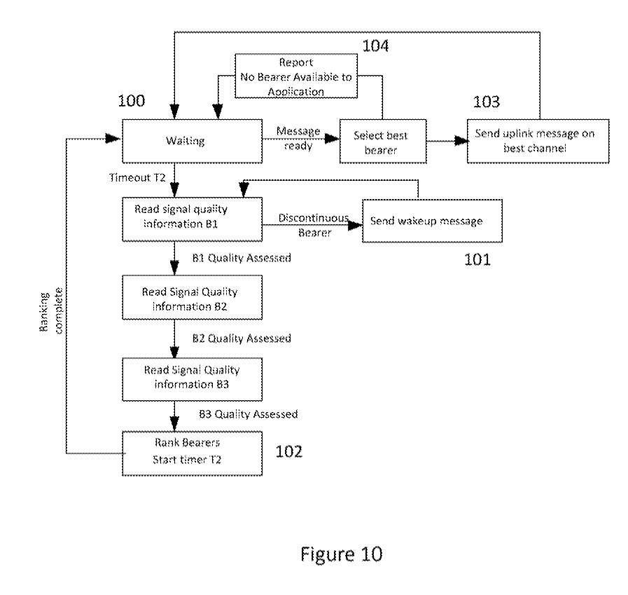

FIG. 10 shows a process for selecting the best bearer. Initially, the hub is waiting 100 until a periodic timer T2 times out such that the process of bearer quality needs to be reassessed. Each bearer B1, B2, B3 is polled for its signal quality measure. In some instances, the downlink may not be continuous and as a result, a wake-up message 101 may be transmitted on that bearer simply to cause a downlink to occur to enable measurement of that bearer. Once each of the bearers are measured, they are ranked 102 according to best available. If a new message is ready to be sent via the hub, the message is automatically transmitted 103 via the best available bearer thereby maximising its probability of getting through on the uplink. If no bearers are available then an out of coverage message is produced 104.

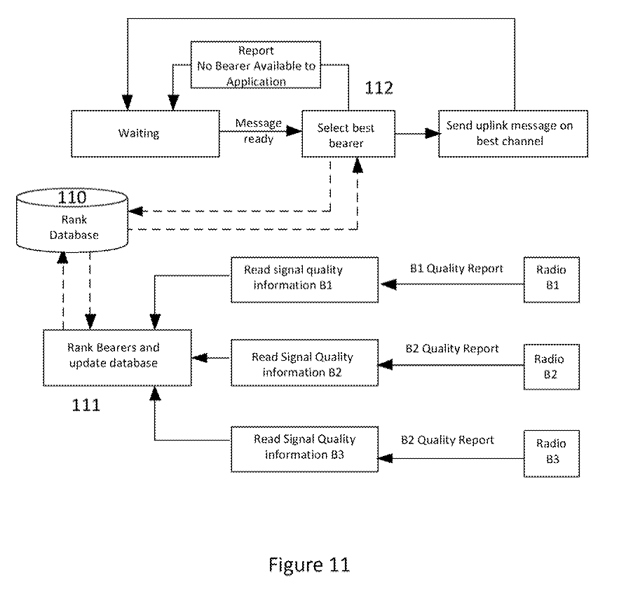

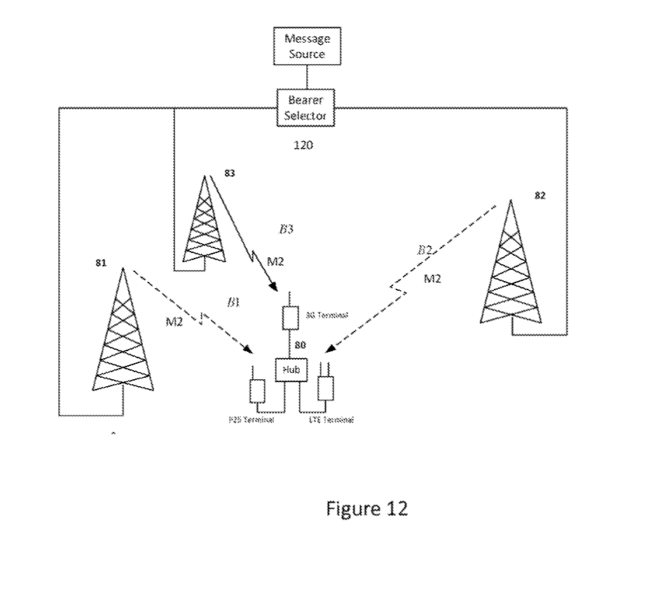

FIG. 11 shows an alternative method of selecting the best bearer. In this case, each bearer radio is periodically producing an update of its signal quality as a function of its own interrupt routine. Each update is used to re-rank 111 a database 110 of available bearers such than when a message is ready to be sent, the hub can simply read from the rank list and make a path selection 112. The downlink path can also be selected. This is shown in FIG. 12. Here, the bearer selector 120 can choose between three paths. In the illustration, message M2 is transmitted via bearer 2.

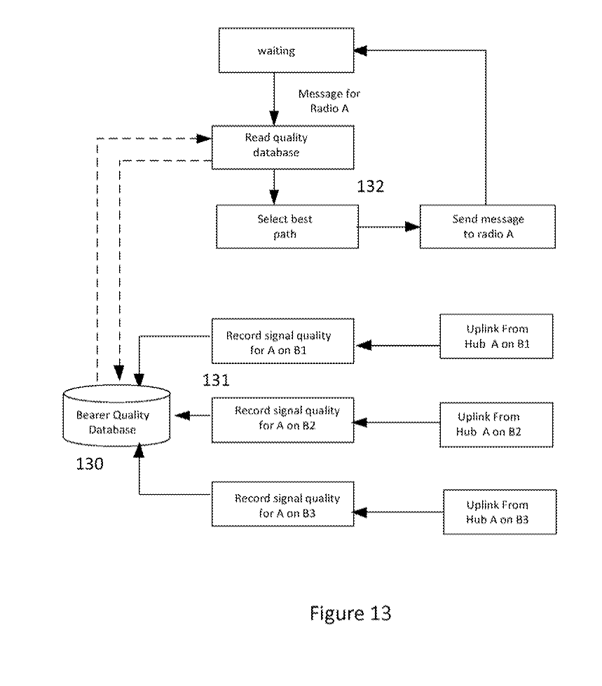

FIG. 13 shows a process for ranking the best downlink channel based upon recent uplinks. A message is destined for delivery to radio A. Radio A may have recently uplinked on bearer 1, 2 or 3. For each uplink made by radio A, the bearer used and the signal quality observed is recorded 131 in database 130. This recent history of activity can be used to select 132 which bearer should be used to downlink the message for the best chance of getting through. If there has been no activity from radio A then transmission over all bearers may take place.

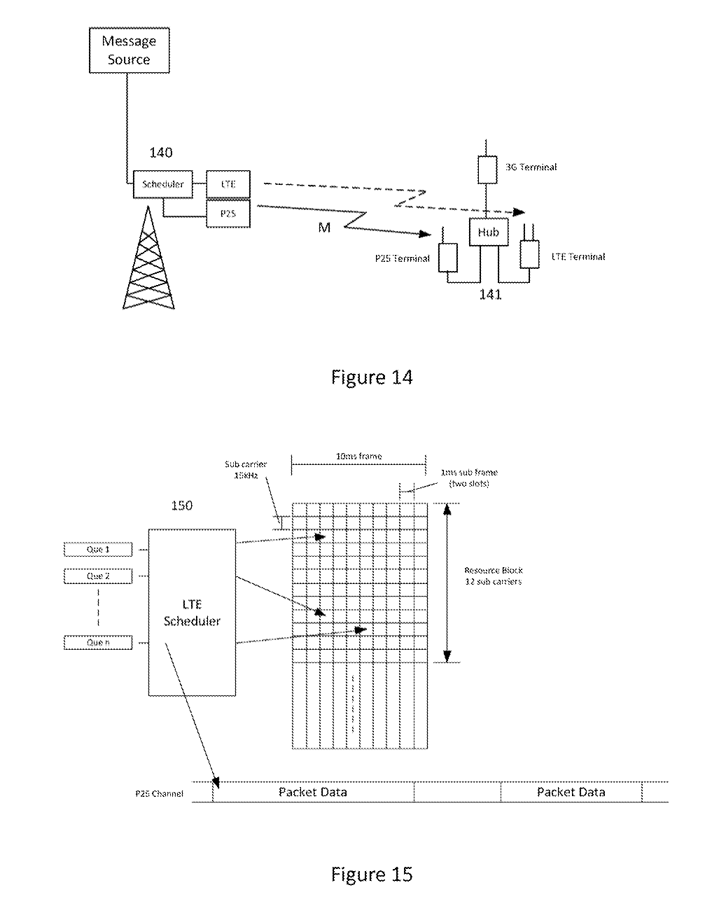

FIG. 14 shows a further mode of operation involving bearer selection in a radio network having both LTE and P25 and connectivity. The network generally includes a scheduler 140 located at one of the base sites or at a dedicated location. The scheduler determines which resource element to use in an LTE downlink based on channel quality reports from the LTE terminals. In this example, a P25 channel is added as an available resource through which the scheduler can send a message M to a unit 141. If the scheduler detects the LTE path is either unsuitable for RF reasons, such as out of coverage, or there is a preferential reason, such as security, to use a P25 path then the message can be directed down the P25 path as shown.

FIG. 15 shows some scheduling structures in LTE including a scheduler 150 for radio resource management. An LTE scheduler receives queues of data from various applications and allocates the data to specific elements of the available resources in the LTE frame. In this example, a number of queues 1 . . . n are being allocated to parts of the LTE frame within a single resource block. The resources used within the frame for each queue will vary as a function of the Quality of Service and the current state of the channel. This process of selecting the resource within the LTE channel is normal operation. In this case a data stream is also allocated to a P25 channel for occasions where either RF conditions preclude LTE or where LTE is no longer able to provide sufficient capacity. In this case data is allocated to a P25 channel on a separate frequency using the standard packet data mode of operation.

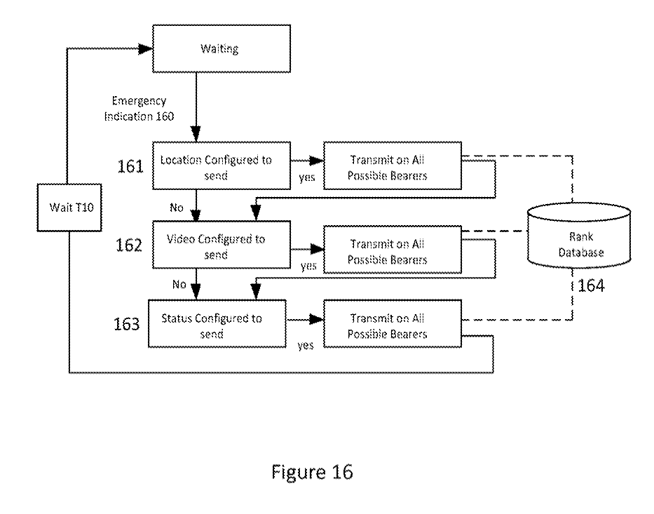

FIG. 16 shows another mode of operation in which an emergency call may be initiated. Emergency calls are common on LMR radios but where multiple bearers are available an emergency message may be transmitted simultaneously rather than sequentially over some or all of the bearers with a view to maximising the chance of the message being received. In this example, when an emergency connection is initiated 160, messages such as location 161, video 162 or status 163 are reported on all available bearers. This is done periodically as a function of a timer T10. The ranking database 164 is generally not required as the messages all carry equally high priority and are transmitted together through respective terminals if possible.

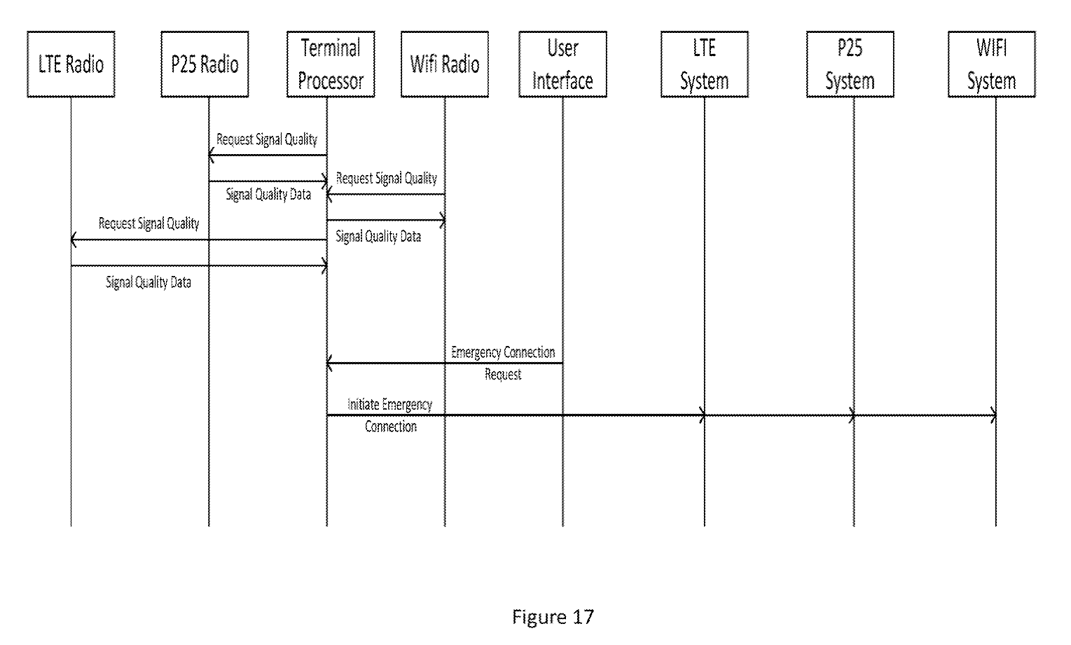

FIG. 17 provides a simple sequence diagram for emergency communication. The hub process is periodically requesting signal quality information from each of the bearer terminals which include LTE, P25 and WiFi in this case. If an emergency call is initiated from the user interface, the terminal processor will send emergency data over an emergency connection over all available bearers irrespective of the signal quality or the current channel allocations defined on those bearers. Simultaneous establishment of the emergency connection across all available bearers is preferred. In an optional implementation, the emergency connection may be attempted across all bearers irrespective of whether quality assessment has concluded there is no connection available.

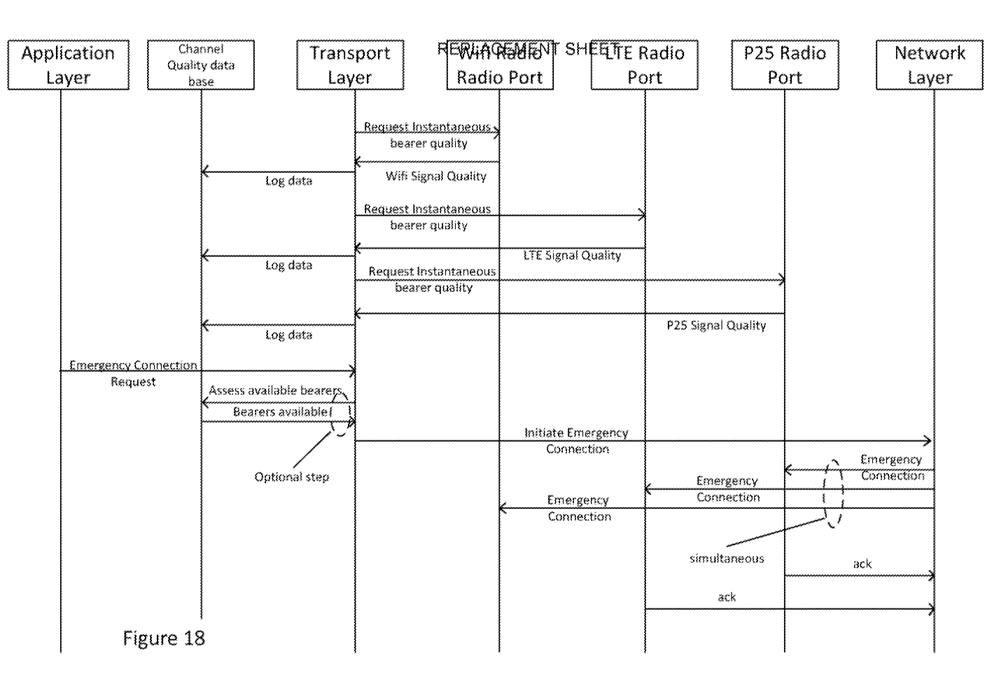

FIG. 18 provides more detail relating to FIG. 17, including operation within the protocol stack of the terminal processor as connections are established. The status of the bearers is periodically assessed through interaction between the transport layer and the ports connecting the plurality of radio bearers available. Each radio bearer is periodically assessed and the result of that assessment logged in a data base held on the processor. Upon an emergency connection request arriving from the application layer, the list of available bearers is assessed. The transport layer communicates with the radio ports directly. This is a simplification for the purpose of clarity.

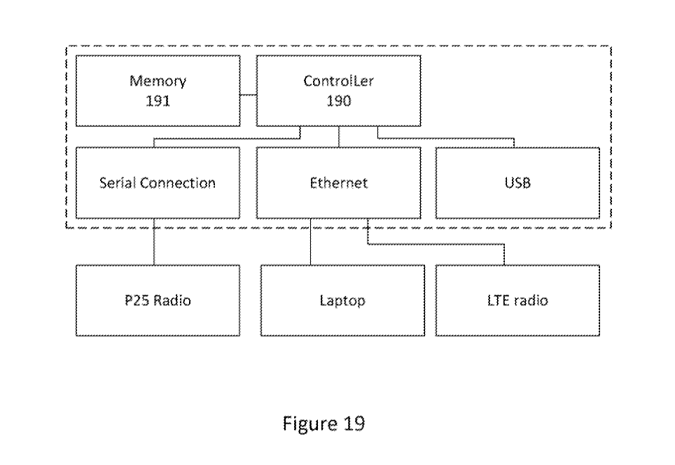

FIG. 19 schematically shows a hub. A controller or processor 190 operates algorithms such as those described above for scanning and bearer selection. Memory holds program and data information required to carry out the algorithms. A set of physical interfaces are available shown here as Serial, Ethernet and USB. In this example the serial connection is used to interface a P25 terminal. Control and user data pass across this interface. An Ethernet connection is used to link with an LTE terminal. Ethernet is also used to communicate with a user application operating on a laptop.

What is claimed and desired to be secured by Letters Patent of the United States is:

1. A method for emergency communication in a public safety radio system having multiple bearers, including:
activating an emergency process;
transmitting emergency information on a first available bearer; and
simultaneously transmitting emergency information on one or more further available bearers.

2. A method according to claim 1 wherein the emergency information transmitted on all available bearers without being prioritised or sequential.

3. A hub for use with bearer terminals in a multibearer radio system, having a processor and memory, wherein the memory contains software instructions which cause the processor to simultaneously transmit emergency information on all available bearers.

4. A method for implementing downlink diversity for a multi-bearer radio communication system, comprising:
transmitting a first copy of a message on a downlink via a first radio bearer;
transmitting a second copy of the message on a downlink via a second bearer;
receiving the first and second copies at a radio unit; and
selecting or combining the received messages to improve radio coverage and/or reliability.

5. A method for implementing a scheduler for a multi-bearer radio communication system, comprising:
assessing the link quality of a first bearer;
assessing the link quality of a second bearer;
depending upon the relative quality of the links; and
scheduling communication over one or other bearer.

6. A method for implementing uplink diversity in a multi-bearer radio communication system, comprising
transmitting a first copy of a message on an uplink via a first radio bearer;
transmitting a second copy of the message on an uplink via a second radio bearer;
receiving the first and second copies at a network station; and
selecting or combining the received messages to improve radio coverage and/or reliability.

7. A method of selecting a radio bearer at a multi-bearer unit in a radio communication system, comprising:
measuring downlink signal quality of data from a first bearer;
measuring downlink signal quality of data from one or more further bearers; and
either selecting an acceptable bearer for uplink communication, or continuing to measure downlink signal quality of the first and further bearers until an acceptable bearer is detected.

8. A method according to claim 6 wherein all available bearers are ranked before selection.

9. A method according to claim 6 wherein the unit remains with a selected bearer while continuing to measure bearers for further selection.
